(19) United States
(12) Patent Application Publication
(10) Pub. No.: US 2012/0084137 A1
(43) Pub. Date: Apr. 5, 2012

(54) Method for Creating, Distributing, and Tracking Variable Coupons

(76) Inventor: Kotaro Shimogori, Pacific Palisades, CA (US)

(21) Appl. No.: 13/252,136

(22) Filed: Oct. 3, 2011

Related U.S. Application Data
(60) Provisional application No. 61/404,408, filed on Oct. 2, 2010.

(51) Int. Cl. G06Q 30/02

(52) U.S. Cl. 705/14.39

(57) ABSTRACT

A method and system for generating dynamic coupons for items in which a discount amount of a first product is dependent on other products selected by the consumer. The method and system allows a seller to establish a set of rules for calculating a discount amount for products it sells. On a designated website, the consumer can select a variety of products available at discount prices. Each time the consumer selects a product the amount of the discount for the products may change depending on the rules established by the seller of those products. When the consumer has completed her selection, a coupon can be generated and printed or sent to a mobile device to redeem at the indicated store. A map can be generated to help the consumer locate the most convenient stores.

### CROSS-REFERENCE TO RELATED APPLICATION

This patent application claims the benefit of U.S. Provisional Patent Application No. 61/404,408, filed Oct. 2, 2010, which application is incorporated in its entirety here by this reference.

### TECHNICAL FIELD

This invention relates to a method and system for generating coupons.

### BACKGROUND

Providers of goods and services often times offer discounts for their goods and/or services to encourage consumers to purchase these goods and/or services and keep the market competitive. Discounts are usually provided in the form of a coupon found in newspapers, magazines, and on the Internet. These coupons also serve as a marketing tool for the manufacturers and service providers.

However, traditional coupons are static, meaning that the amount of the discount offered on the coupon is fixed and does not change. The only way to more on a particular coupon is to buy more of that product. Otherwise, the percentage of the discount relative to the retail price remains the same. These static coupons are limited in the amount of discount a particular manufacturer or service provider offers. These static coupons are also limited in the promotion of competition among the manufacturers and service providers.

For the foregoing reasons there is a need for improving the competition and discounts offered to consumers, particularly in times of economic hardship, to help stimulate the economy.

### SUMMARY

The present invention is directed to a method and system for generating, distributing, and tracking variable or dynamic coupons. Variable or dynamic coupons are not those in which the amount of the discount can change depending on the combination of products purchased by a consumer. The invention is realized as an Internet based website. The website displays a list of products available for discounted pricing. Sellers can establish rules that determine the discount amount of their products. Buyers or consumers can alter the amount of a discount for a particular product by selecting other products displayed on the website.

By mixing and matching different products, consumers can maximize their discount. Sellers are encouraged to establish rules that will maximize discount offers to consumers. Otherwise, if a buyers selection of a particular product causes the discount of another product be smaller, the buyer may not purchase the first product. This will cause the seller to change its rules so that it does not cause other products' discounts to go down.

### BRIEF DESCRIPTION OF DRAWINGS

FIG. 1 shows an embodiment of a website of the present invention;

FIG. 2 shows the website in FIG. 1 with an item selected;

FIG. 3 shows the website in FIG. 2 with a second item selected;

FIG. 4 shows the website of FIG. 3 with a third item selected;

FIG. 5 shows the website of FIG. 4 with a fourth item selected;

FIG. 6 shows the website of FIG. 5 with a fifth item selected;

FIG. 7 shows an embodiment of a dynamic coupon;

FIG. 8 shows an embodiment of a static coupon;

FIG. 9 shows an embodiment of an online form to create a dynamic coupon;

FIG. 10 shows an embodiment of an online form to create a static coupon;

FIG. 11 shows an embodiment of a seller's management page;

FIG. 12 shows another embodiment of a seller's management page;

FIG. 13 shows another embodiment of a seller's management page;

FIG. 14 shows an embodiment of a notification page;

FIG. 15 shows another embodiment of a notification page;

FIG. 16 shows a flow diagram for a consumer;

FIG. 17 shows a flow diagram for a seller; and

FIG. 18 shows a flow diagram for creating a coupon.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The present invention is a method and system for creating, distributing, and tracking coupons utilizing an internet website that allows sellers of goods or providers of services (“Sellers”) to offer discounts for the products or services (collectively referred to as “products” or “items”) they offer, distribute those discounts, and track the discounts redeemed. Sellers can establish certain items for which a discount is available and establish a set of rules to determine the amount of the discount. Unlike traditional coupons with a fixed discount for a particular item, the amount of the discount offered in the present invention depends on other items selected by the user for purchase.

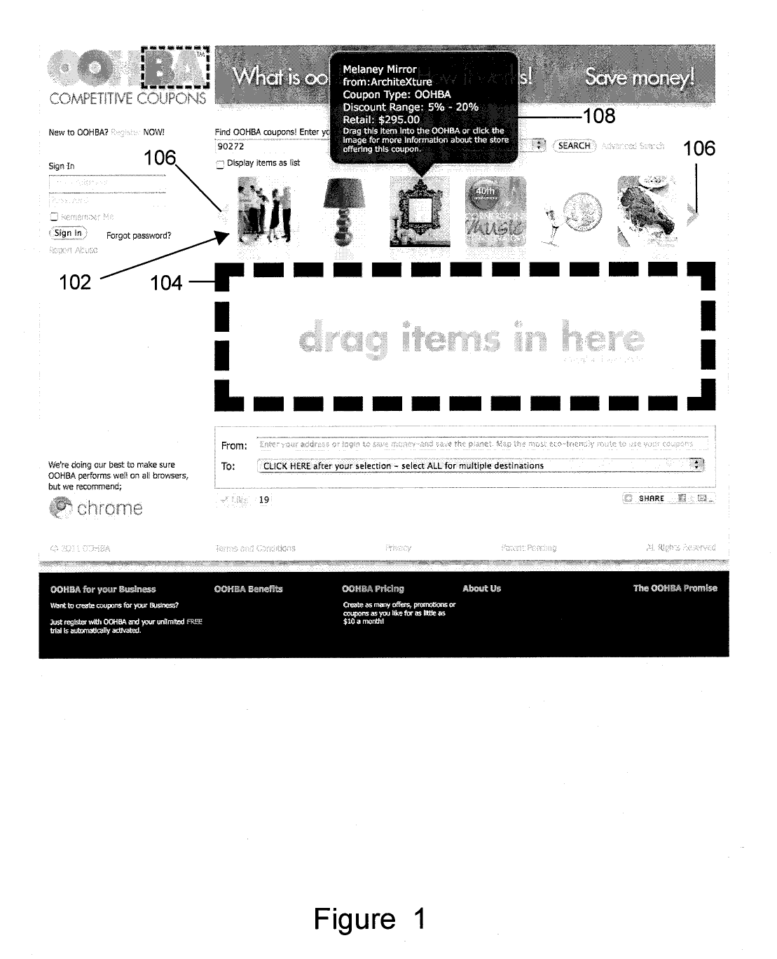

As shown in FIG. 1, the present invention comprises a website displaying images 102 of items for sale that are eligible for a discount. The consumer visiting the website can browse through the available items and select an item of interest. In this example, an item is selected by clicking on the image 102 and dragging it into a selection box 104.

The items can be displayed in any fashion. For example, the item may be displayed as a list, as a thumbnail image, in a gallery view, list view, and the like. In the example shown in FIG. 1, items are shown as thumbnail images 102 in a linear arrangement. Arrows 106 are provided to scroll to the left or right to view more items. Options can be provided to change the display format, the number of items shown at a time, and the like.

In some embodiments, clicking on the item will open a new window with a description of the item. A description of the store selling the item may also be displayed. In some embodiments, simply hovering the cursor over the item will display a pop-up 108 with a short description of the item. Clicking on the item may open a new page with a more detailed description of the item, including information regarding the store selling the item.

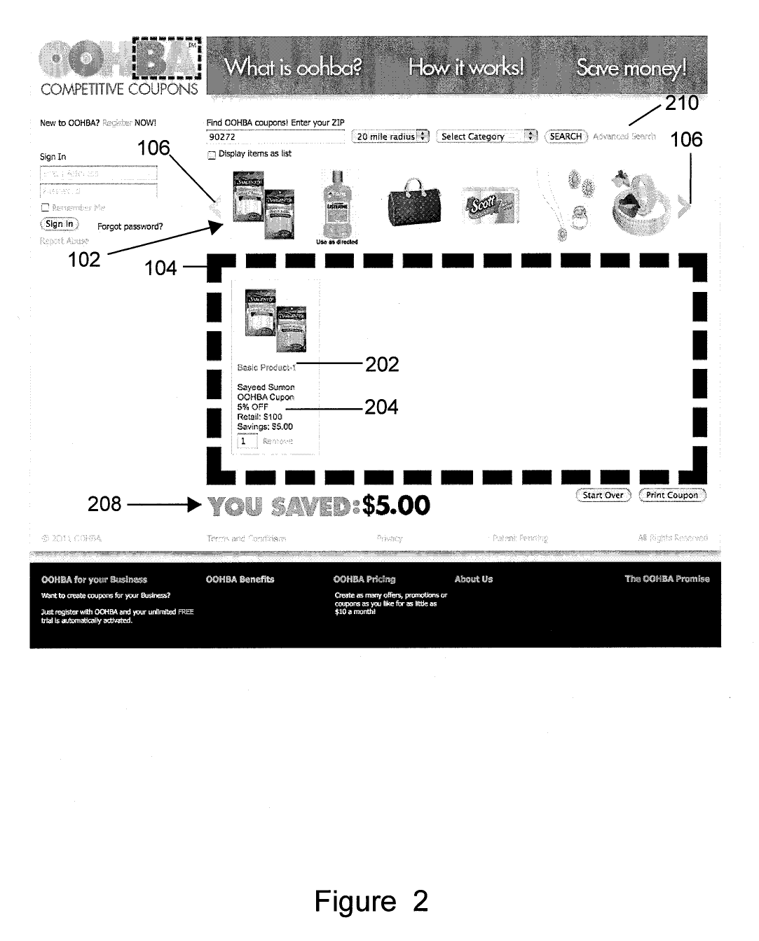

As shown in FIG. 2, the selected item 202 is displayed in the selection box 104 with an item-specific sales information 204. The item specific sales information 204 may contain product information (i.e. description of the product), discount information (e.g. amount of savings, percent savings, sale price, etc.). For example, the item specific sales information 204 may contain the retail price of the item, the percentage off, the dollar amount saved, or the discounted price, or any combination thereof. The discount information is determined by a set of rules established by the seller. In the preferred embodiment, the set of rules involves the selection of other items. In other words, the discount offered for any one item may be dependent on the selection of another item, thereby, creating a variable or dynamic coupon 702 that depends on the other items selected.

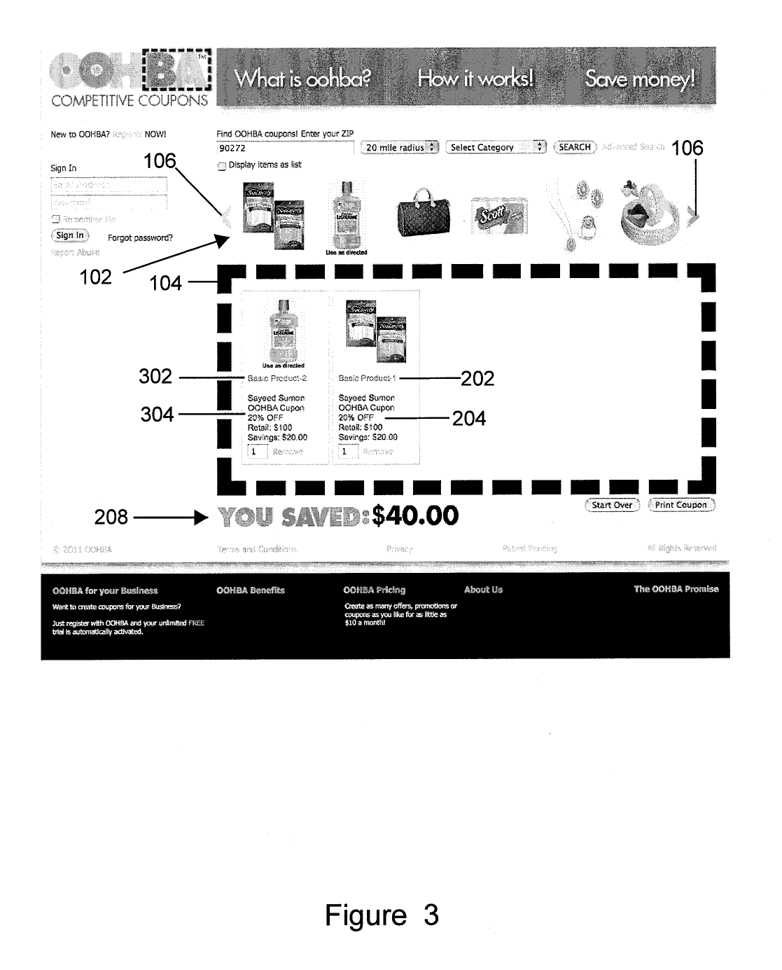

As shown in FIG. 3, a second item 302 can be selected. The second item is displayed in the selection box 104 with its item specific sales information 304. The first item-specific sales information 204 (specifically, the discount amount) may change based on the selection of the second item 302. In this example, the first item 202 (Basic Product-1), when selected alone, was discounted at 5% of the retail price. However, when the second item 302 was selected (Basic Product-2), the discount on the first item rose to 20% of the retail price. This change was due to the rules established by the seller for the first item 202.

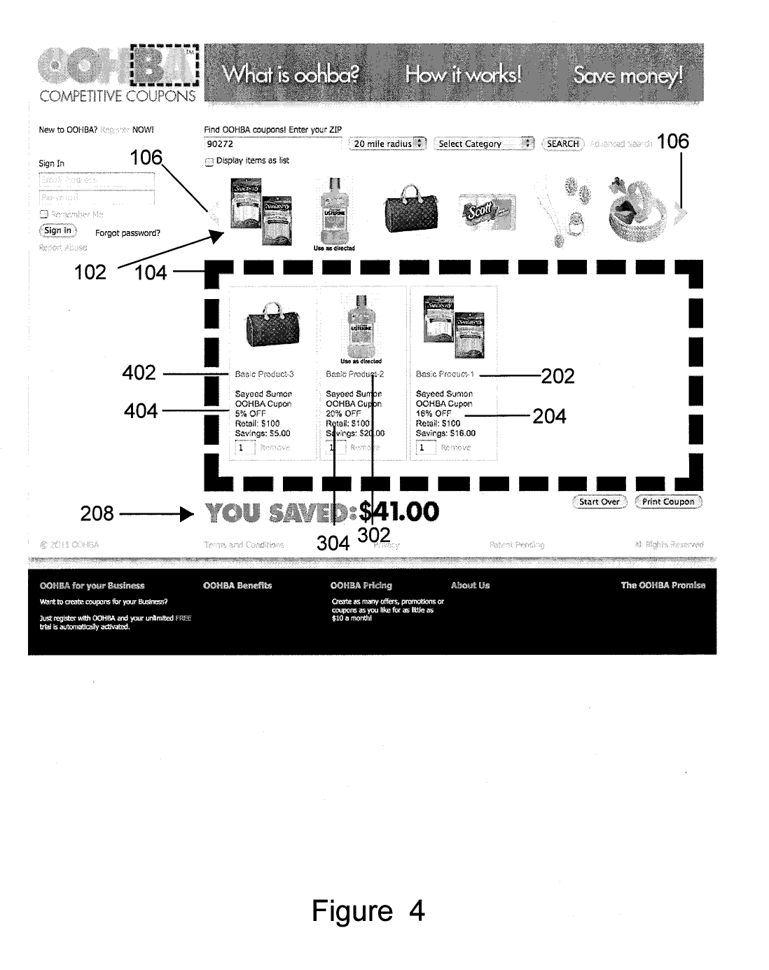

As shown in FIG. 4, when a third product 402 is selected (Basic Product-3), the sales information 404 of the third product 402 is displayed, and the sales information of the first and second products 202, 302 are updated and the updated discounts are displayed. In this example, based on the rules established by the sellers, selection of the third item 402 did not affect the discount on the second item 302 (still 20%), but made the discount on the first item 202 smaller (now 16%).

The reduced discount on the first item has at least two effects. From the consumer's perspective, the consumer may no longer want to purchase the third item 402. To the consumer, selecting items for purchase becomes like a game as the consumer tries to find the right combination of items that results in the greatest discount.

The seller on the other hand, will have to reconsider the rules established for its item so as to avoid consumers deselecting its items because of the negative effect it had on the discount of other items. In some embodiments, the server may monitor this type of activity and report it to the seller to help the seller manage its coupon generating activity. This may force sellers to be more competitive with their discounts.

In some embodiments, to prevent the discounts from going lower, the seller may establish a rule that only allows discounts to stay the same or go up, but not to go down. In other words, if the updated discount is less than the current discount, then the current discount can be posted and applied.

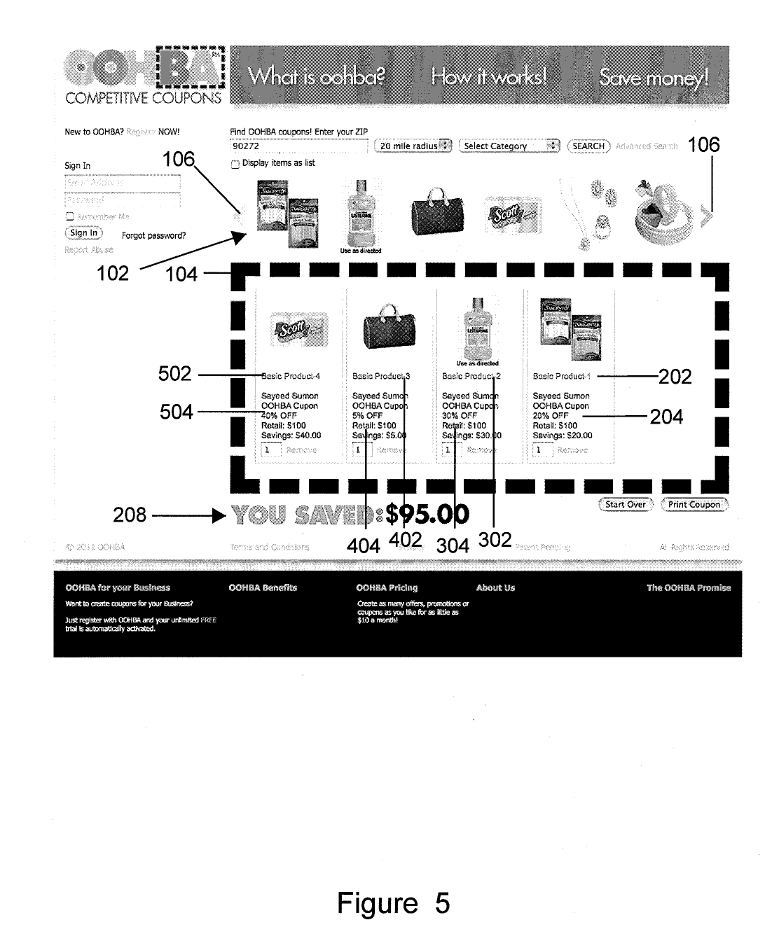

Application of the rules for the discount can cause the discount to fluctuate up, down, and remain the same. In the example shown in FIG. 5, the addition of a fourth item 502 causes the discount of the first item 202 to go back up and also causes the discount of the second item 302 to go up. Thus, the consumer would not have had to deselect the third item 402 to capitalize on the discount of the first item 202. All he or she had to do is find the right item that maximizes discounts.

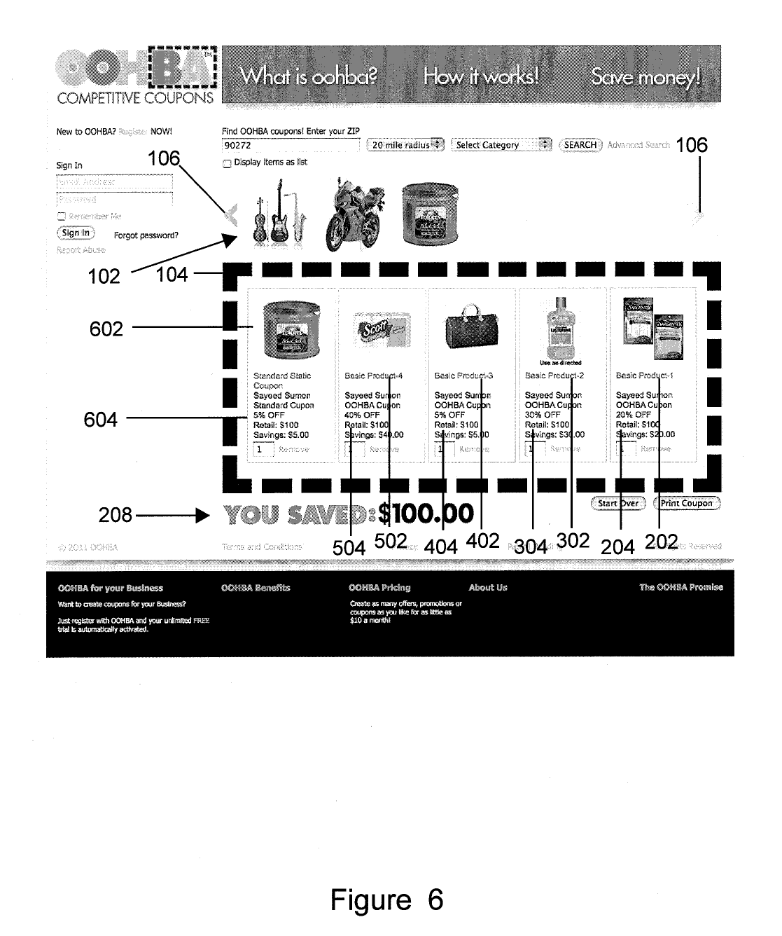

Finally, as shown in the example in FIG. 6, there are items that have traditional, non-variable or static discounts 604. In the preferred embodiment, selection of these static discount products 602 does not affect the discount of the dynamic discount products 202, 302, 402, and 502. However, in some embodiments, static discount items 602 can be used to alter the discounts of the dynamic discount products 202, 302, 402, and 502.

While the consumer is selecting items for purchase 102, a total discount information 208 can be displayed showing, for example, the total dollar amount, the total percentage amount, or some other indication of the total amount saved for all of the selected items compared to the cost without any discounts.

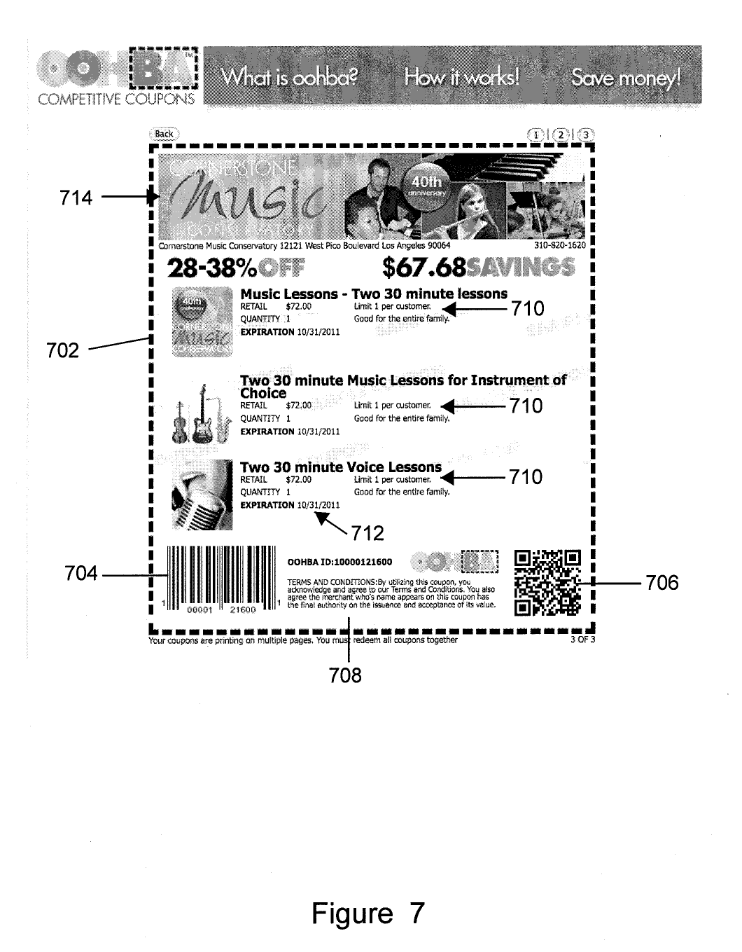

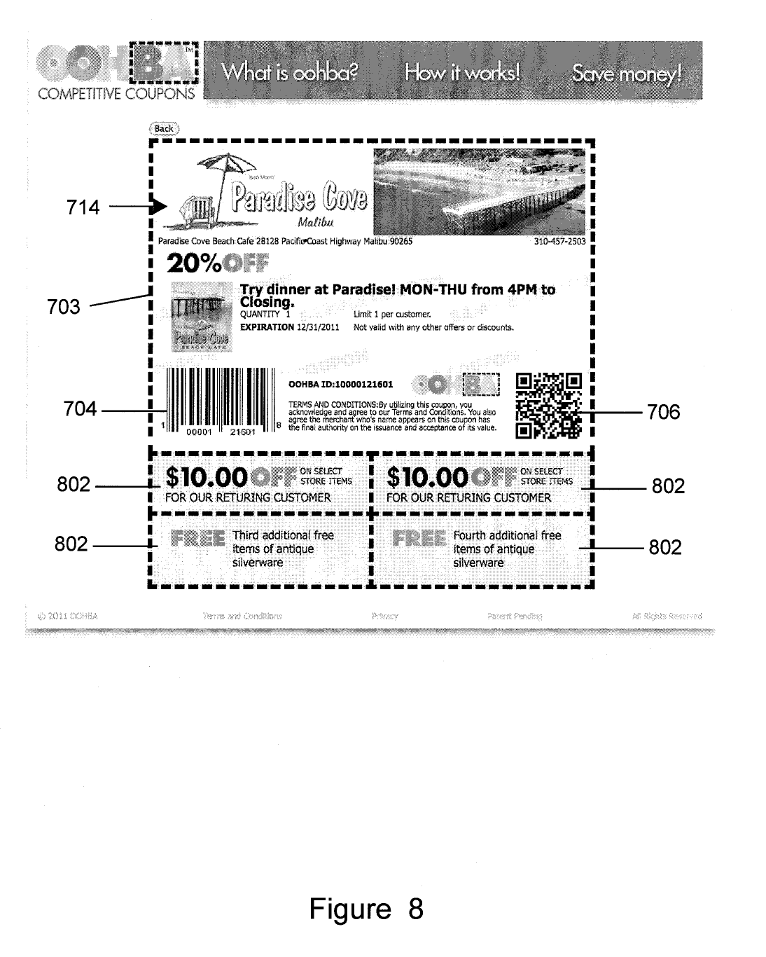

Once the consumer has completed his or her selection of items to purchase, the consumer can elect to print a coupon 702 or have the coupon 702 sent to a mobile device. FIGS. 7 and 8 show a sample of a coupon 702 generated from the selection of certain items. In the preferred embodiment, in order to take advantage of the discounted price all items may be printed on a single coupon 702 rather than a separate coupon for each item as in traditional coupons. In some embodiments, only items located at the same store may be printed on a single coupon 702. This reduces the possibility of fraud by the consumer who selects certain items for the purpose of maximizing a discount of another item without intending to buy all the items selected. By putting all of the items on a single coupon 702, the store can confirm whether every item on the coupon 702 was purchased at the store.

In some embodiments, if an item is not available, accommodations can be made to have the item shipped to that store from another store, picked up at a sister store in another location, shipped directly to the consumer, placed on backorder or raincheck, and the like. In some embodiments, if the item is unavailable at a store, then the consumers may be excused from having to purchase that item to get their discount since it was not their fault that they could not purchase all of the items on the coupon 702.

In some embodiments, enforcing this rule may not be feasible, particularly when multiple items are purchased at different stores, so the consumers will be left to an honors system. For example, if a consumer received a particular total discount for five items, two of which are sold at a first store, and three of which are sold at a second store, then the consumer can go to the first store and purchase all of the items on the coupon 702 sold at the first store at the discounted price on the coupon 702. However, the consumer may not go to the second store, since the items he really wanted were sold at the first store and he got the discount that he wanted.

In some embodiments, a rebate system may be utilized to force the consumers to purchase all selected items that led to a particular discount, in order to realize their full discount. In the example above, if the consumer purchases the three items on the first coupon 702 for the first store, but never purchased anything from the second store, then the consumer would not receive his rebate because the first store would submit the redeemed coupon 702, but the second store could not. Therefore, the system would know that not every item on the list required for the discount was actually purchased, and would not send the consumer the rebate in the amount of the discount.

To facilitate the processing of the coupon 702, the coupon 702 may display a bar code 704, QR code 706, and the like. Other relevant information may also be displayed on the coupon, such as terms and conditions 708, limitations 710, expiration 712, bonus offerings 802, store information 714, and the like.

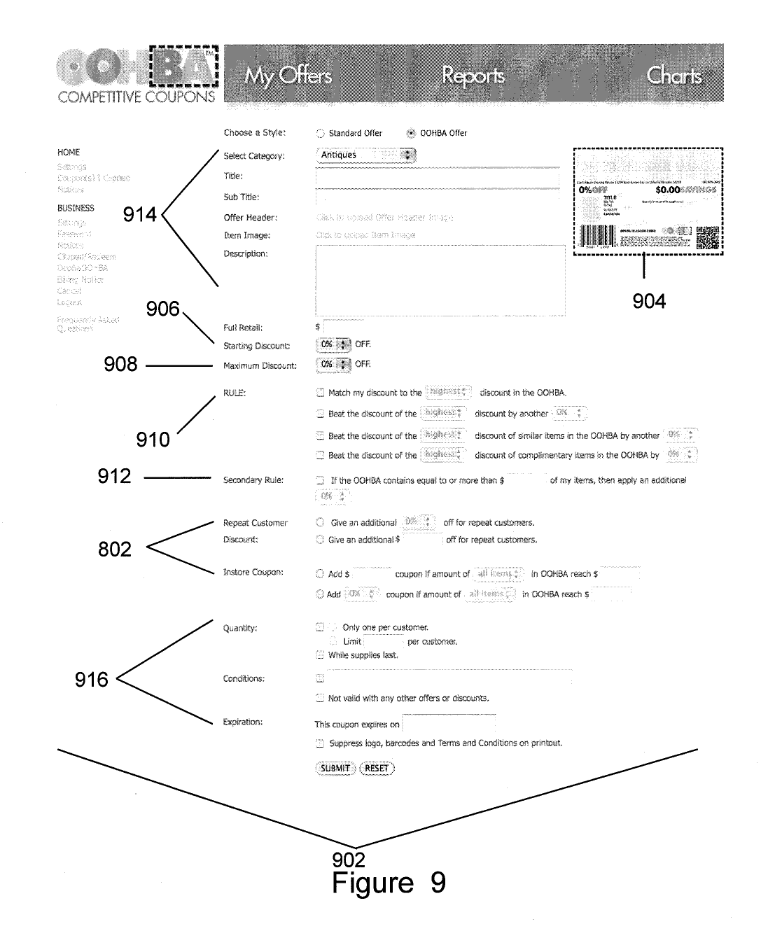

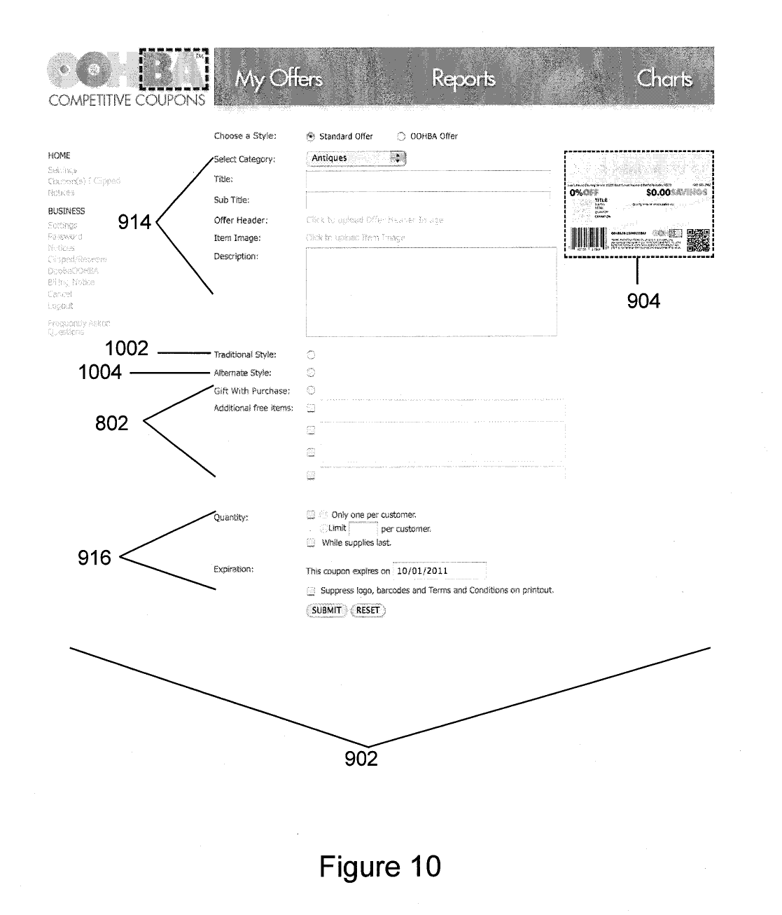

To create a coupon 702, a seller must first register with the system. Once registered, the seller fills out an online forms 902, 903 like the examples shown in FIGS. 9 and 10. The seller can select the type of coupon it wants to generate. For example, besides the dynamic or variable coupon, the seller is permitted to create standard, non-variable coupons. Both types of coupons 702 allow the seller to input the display information 914, such as the category of the item to be discounted, the title of the item, a subtitle, an offer heading, an image of the item, a description of the item, the retail price of the item, the discount style, and the like. The discount style 1002 may be the traditional style in which the percentage off is displayed, or an alternate style 1004 such as the final cost of the product. A preview image 904 of the coupon 702 may be displayed to show the seller how the display information would appear on the coupon 702. An option may be available to suppress any of the display information on the coupon 702 in any combination.

The seller will also be given the opportunity to elect bonus offers 802 to the consumer. For example, certain items may come with a bonus gift (e.g. a freebie) with purchase of the item, an additional discount for shopping in stores (rather than on-line), an additional discount for repeat customers, and the like. The system may allow the seller to describe the bonus offer 802 and what is required to get the bonus offer 802. For example, for the free gift, an additional percentage or dollar figure off may be offered under specified circumstances.

The seller also has the opportunity to establish certain conditions 916 for the coupon 702. For example, the seller can determine the number of coupons per customer, the number of items that can be purchased with a single coupon 702, the expiration of the coupon 702, and the like.

The distinguishing feature between the standard coupon 703 and the dynamic coupon 702 is that in the dynamic coupon 702, the seller established the rules to determine the dynamic nature of the dynamic coupon 702. For example, the seller can establish preliminary rules 906, 908, primary rules 910, secondary rules 912, and the like. The preliminary rules 906, 908 may establish the starting discount and the maximum discount of an item.

The primary rules 910 establish the algorithm to use in calculating the discount based on other items selected by the consumer. For example, the one primary rule 910 may be to match the discount of an item to the highest, lowest, or average discount of other items selected by the consumer. Another primary rule 910 may be to beat the discount of the highest, lowest, or average discount of the items selected by the consumer by a certain amount. Another primary rule 910 may be to beat the highest, lowest, or average discount of only similar items selected by the consumer, and to beat that discount by a specified amount. Another rule 910 may be to beat the highest, lowest, or average discount of complimentary items selected by the consumer.

The system may also offer the seller to establish secondary rules 912. These rules may be in addition to the primary rules 910, or to modify the primary rules 910. For example, a secondary rule 912 may be that if the consumer's selected items is greater than a predetermined amount, then an additional predetermined discount may be applied to the item.

Finally, there may be a hierarchy of rules in the event there are inconsistent results from application of the rules. For example, according to a hierarchy, the preliminary rules 906, 908 may trump the primary 910 and secondary rules 912. In situations where there are multiple primary rules 910, the hierarchy may be to apply the primary rule 910 resulting in the greatest discount without violating the preliminary rule.

To demonstrate the application of these rules, the following non-limiting example is provided based on the rules defined for each item below with reference to FIGS. 1-6:

For Basic Product-1 202, the discount range is 5%-20%. The primary rule 910 is to match this discount to the average discount of all discount ranges of all items selected by the consumer.

For Basic Product-2 302, the discount range is 10%-30%. The primary rule 910 for this item is to match this discount to the highest possible discount of all items selected by the consumer.

For Basic Product-3 402, the discount range is 5%-20%. The primary rule 910 for this item is to match this discount to the lowest possible discount of all items selected by the consumer.

For Basic Product-4 502, the discount range is 10%-50%. Two primary rules 910 are established. The first primary rule 910 is to match this discount to the average discount of all discount ranges of all items selected by the consumer. The second primary rule 910 is to beat the discount of the highest possible discount by another 10%.

Basic Product-5 602 has been designated to generate a standard static coupon with a discount of 5%.

Referring to FIG. 2, Basic Product-1 202 is selected by the consumer. As the only item currently selected, the discount is set to the minimum of 5% as designated by its primary rule.

Referring to FIG. 3, Basic Product-2 302 is now selected. The rule for Basic Product-2 302 indicates to match the “highest” possible discount of items selected by the consumer. Therefore, Basic Product-1's 202 highest discount of 20% is applied for now.

Since the Basic Product-1 202 rule indicates to match the “average” discount of the discount range of the items selected, it looks at Basic Product-2's 302 average of 20%. The average is derived from adding 10% and 30% and dividing 2 as there are two percentages. So Basic Product-1 202 now shows a 20% discount.

Referring to FIG. 4, Basic Product-3 402 is now added to the selection. As Basic Product-3 402 rule indicates to match the “lowest” possible discount of the items selected, the system refers to Basic Product-1 202 and Basic Product 2 302 and chooses the lowest discount of 5% and assigns that for now. As Basic Product-2 302 rule indicates to match the “highest” discount of the items selected, the system now looks at Basic Product-1 202 and Basic Product-3 402 and chooses the highest discount of 20% and assigns that for now. As Basic Product-1 202 rule indicates to match the “average” discount of the range of discounts for items selected, the system refers to Basic Product-2 302 and Basic Product-3's 402 discount ranges. As there are 10% and 30% from Basic Product-2 302 and there are 5% and 20% from Basic Product-3 402, all percentages are added, then divided by 4 as there are 4 values. The result is now 16.25%, or 16% when rounded to the nearest whole number.

Referring to FIG. 5, Basic Product-4 502 is now added to the selection. The Basic Product-4 502 rule indicates to match the “average” discount in the selection and to beat the discount of the highest discount by another 10%. The system calculates what the discount would be for each rule. Then, depending on the hierarchy of rules, one of the two rules is applied. For example, the hierarchy may be to use the rule that gives the highest discount or the lowest discount. In this example, the hierarchy was to apply the rule giving the highest discount, so the system utilizes the second rule and looks for the highest discount in the selection, which is from Basic Product-2 302 (30%), and adds another 10% to the discount, thereby, showing 40% off, and updates the rest of the items.

As Basic Product-3 402 rule indicates to match the “lowest” discount in the selection, it looks at Basic Product-1 202, Basic Product-2 302, and Basic Product-4 502 and chooses the lowest discount of 5%, which in this case did not change anything for Basic Product-3 402.

As Basic Product-2 302 rule indicates to match the “highest” discount in the selection, the system now looks at Basic Product-1 202, Basic Product-3 402, and Basic Product-4 502. Basic Product-4's 502 highest discount is 50%. However, applying the hierarchy of rules, Basic Product-2 302 has a maximum discount set to 30%. So the system ignores the 50% discount of Basic Product-4 502 and now assigns Basic Product-2's 302 own highest discount of 30%.

As Basic Product-1 202 rule indicates to match the “average” discount in the selection, the system now refers to Basic Product-2 302, Basic Product-3 402, and Basic Product-4's 502 discount ranges. As the range of discounts are 10% and 30% from Basic Product-2 302, 5% and 20% from Basic Product-3 402, and 10% and 50% from Basic Product-4 502, all percentages are added, then divided by 6 as there are 6 values. The result is now approximately 21% for Basic Product-1 202. However, applying the hierarchy of rules, the discount for Basic Product-1 will be 20% because Basic Product-1's 202 preliminary rules only allows for a maximum discount of 20%.

Referring to FIG. 6, an item is selected that is associated with a standard static coupon 703. Static coupons 703 are not affected by other coupons and may not affect dynamic coupons 702. However, in some embodiments, dynamic coupons 702 may be affected by static coupons 703, while the static coupons 703 remain static.

In some embodiments, the system may make recommendations to the consumer to maximize the discounts of certain items the consumer has already selected. The website may have the standard searching tools 210 as other websites, but also include a search function to maximize discounts of selected items. This helps the sellers with favorable rules advertise their products.

Once all selection is complete, the coupon(s) 702 or 703 may be printed. Along with printing the coupons 702 or 703 or sending the coupons 702 or 703 to a mobile device, the system also provides the consumer with a map and route to the various seller's retail store where the coupon may be redeemed. The map provides the best possible route so as to save time and reduce carbon footprint while shopping.

Coupon(s) 702 or 703 created on the system can be easily linked to any social networking sites such as Facebook, MySpace, etc.

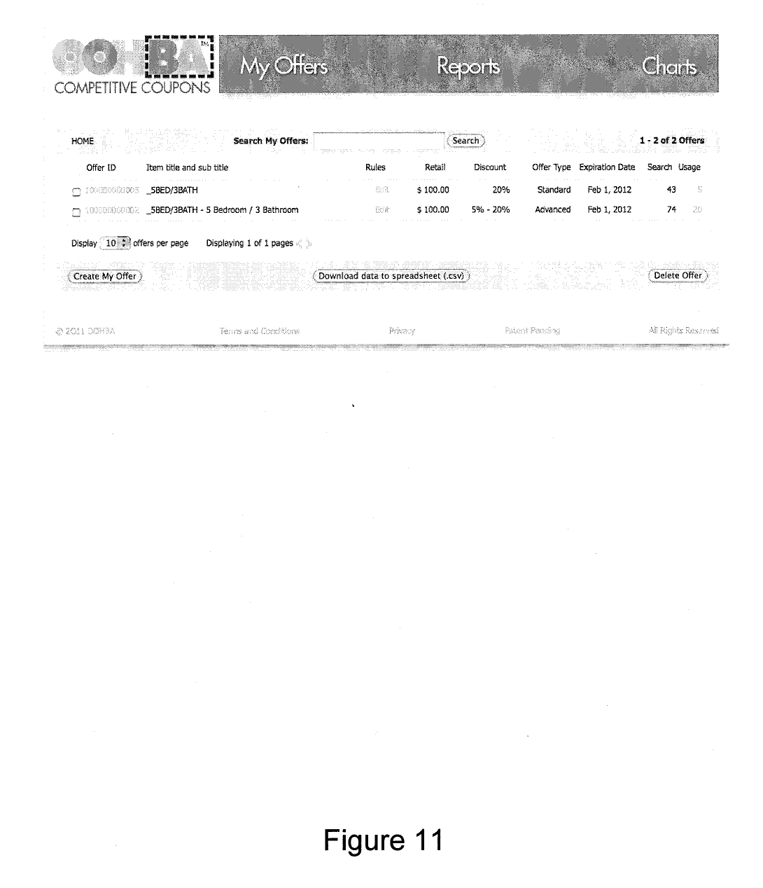

The system gives the merchant administrative tools as seen in FIG. 11. The merchant can see all of its available offers 1102, including details such as item title, retail value, discount, offer type, expiration date, times the offer was searched, and times the offer was used. In addition, the merchant can create new offers, edit old offers, or delete offers.

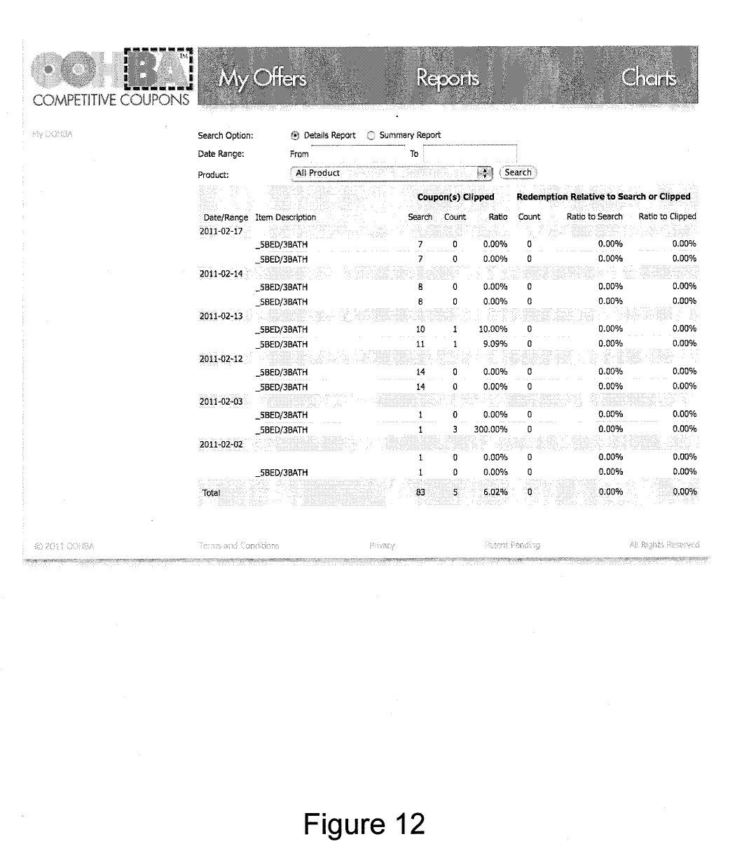

The system gives the merchant the option of generating reports about the activity of its products, including searching by date range and detailed analysis as seen in FIG. 12.

The system also gives the merchant a lot of marketing tools as well. Any static 703 or dynamic coupon 702 created on the system can be sent to any customer(s) via the email system. A seller can even upload a CSV file on the website and send the coupon(s) 702 or 703 to as many customers as defined by the seller.

The system keeps a record of all coupons 702 or 703 searched, clipped (printed), and redeemed by a customer. Once the coupon 702 or 703 is redeemed by a customer, the sellers may logon to the system and mark the coupon 702 as redeemed by that particular customer. This process also lets the customer know the coupon 702 or 703 was redeemed and acknowledged by the sellers and also provide other discounts available only to repeat loyal customers.

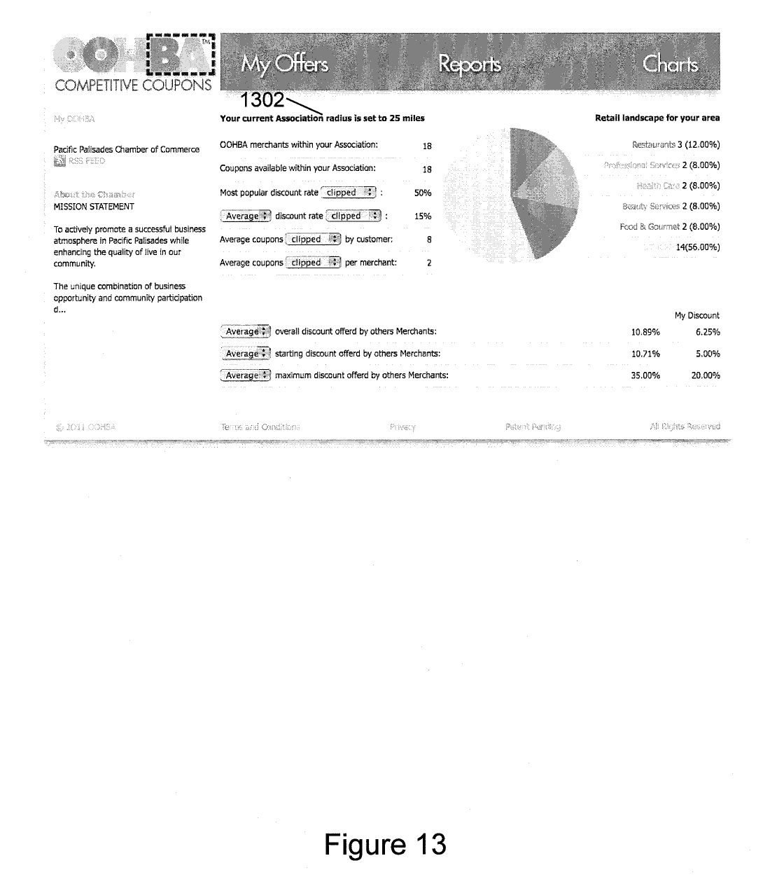

On merchant settings, sellers may enable an association radius 1302. If enabled, this allows the sellers to work with other sellers within the defined radius 1302. This allows the sellers to add even more value to the coupon 702 or 703. For example, two sellers may agree to offer consumers additional discounts if both products are selected by the consumer. As seen in FIG. 13, the merchant can view information about all the merchants in the Association radius 1302.

The consumer, upon logging in, can conduct a search for products in several ways. For example, the consumer can enter her postal code and the system will serve up all available coupons 702 within the consumer's defined radius. The consumer can select any item simply by dragging and dropping any item of interest in the selection box 104 and see the discounts change as more items are selected. Other means for selecting items can be used such as clicking on the image 102 of the item, clicking on a checkbox, and the like. Once the consumer is ready, she can print out the coupons 702 or 703 or have the coupons 702 or 703 sent to her mobile device.

An ecological route to all the stores is then provided to the consumer. Various waypoints are calculated to create the shortest and most effective route to these stores so as to minimize the driving time, hence drastically reducing carbon footprint on earth.

The system keeps track of all coupon generation and uses to help sellers and consumers manage their coupon 702 or 703 generation and use, respectively. For example, if there is a coupon 702 or 703 a consumer would like to use and it has not expired, the consumer can go online again and print out the coupon 702 or 703.

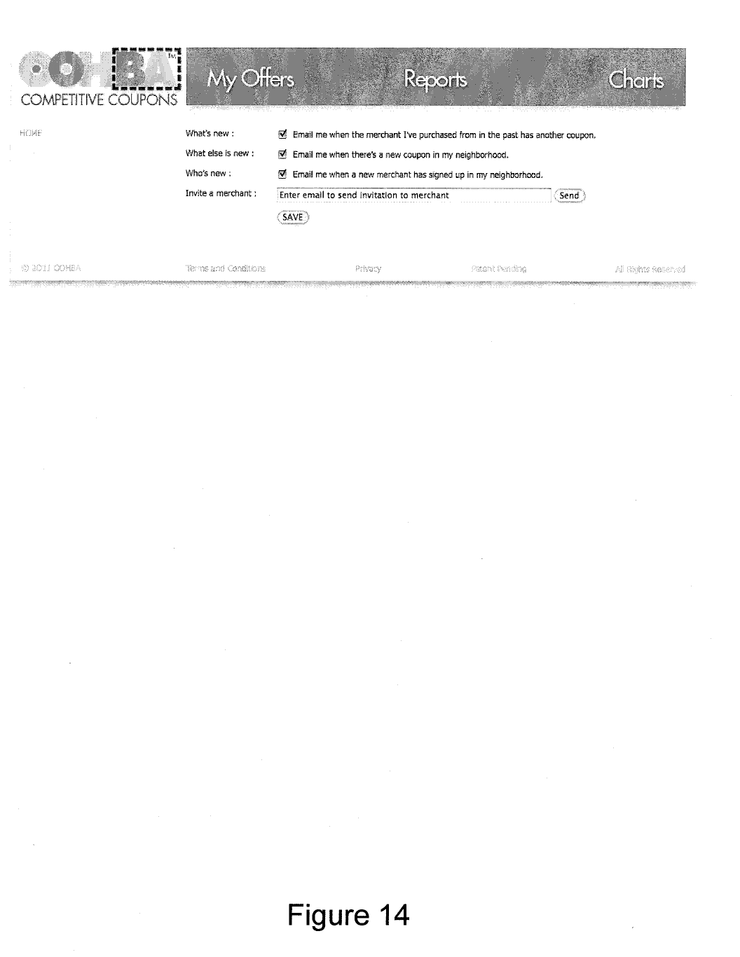

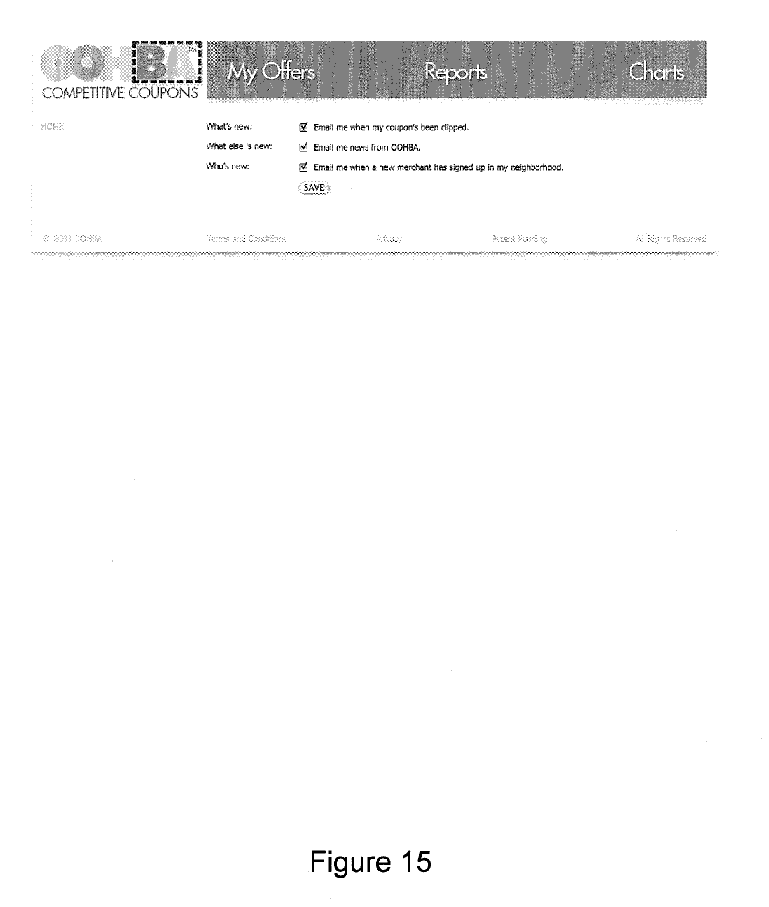

Sellers and consumers can sign up for notifications. Sellers can be notified about information such as their coupon usage and other merchant activity as seen in FIG. 15. Consumers can track such information as new offers by a specific merchant, new coupons in a neighborhood, and new merchants signing up in a neighborhood as in FIG. 14.

Consumers can track their coupon 702 or 703 redemption by going online and validating the coupon 702 or 703 purchase. This gives more points to the consumer and creates loyalty.

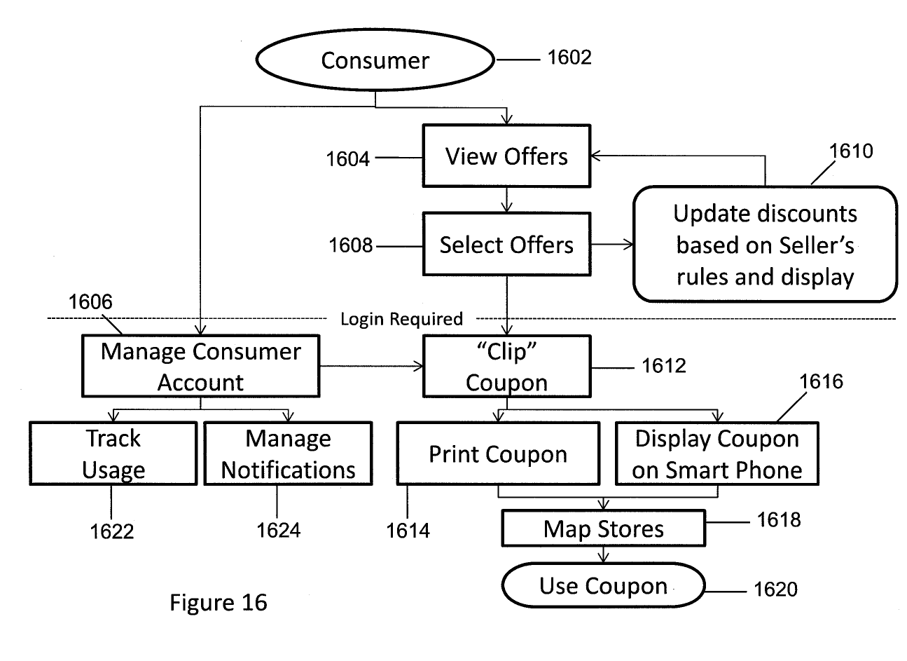

As shown in FIG. 16, when the consumer 1602 logs in to the system, the consumer 1602 can view the offer displayed on the website 1604 or manage his account 1606. While viewing the offers displayed, the consumer can select the items for purchase 1608. The system will display the item and the discount amount and the consumer can continue to select more items for purchase. Each time the consumer selects a new item the discounts are updated 1610 based on the sellers' rules and the updated discounts are displayed. Once the consumer has completed selecting his items, the consumer can choose to generate and clip a coupon 1612. The consumer can either print the coupon 1614 or display the coupon on a mobile device 1616. The system will then map the stores 1618 identified on the coupons and the consumer can go to the store to redeem his coupon 1620.

If the consumer chooses to manage his account, the system will display a webpage showing the has been tracking consumers usage 1622. The consumer can also manage any notifications 1624 that come in from the system.

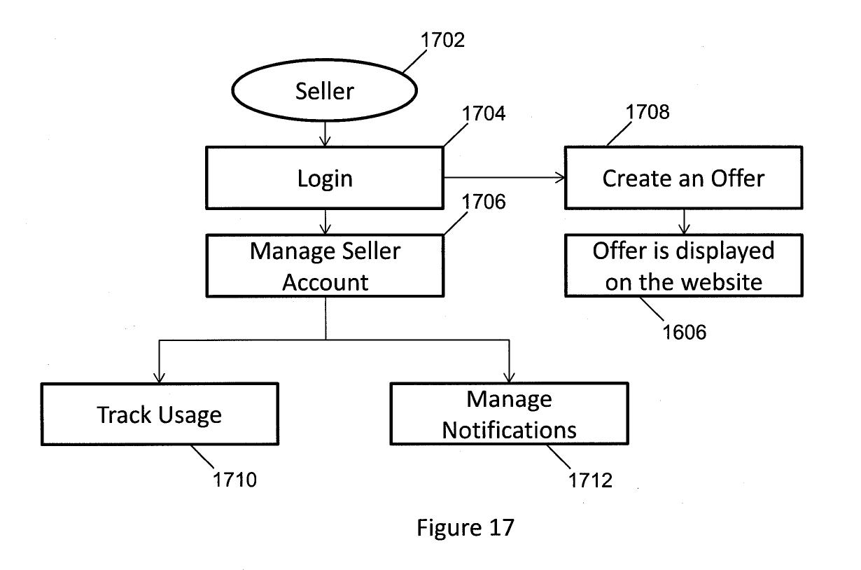

As shown in FIG. 17, the seller 1702 can login 1704 to manage its account 1706 or create and offer 1708. If the seller creates an offer 1708, the offer will be displayed on the website 1606 for the consumer to see. In managing the sellers account, the seller can track its usage 1710 or manage notifications received from the system 1712.

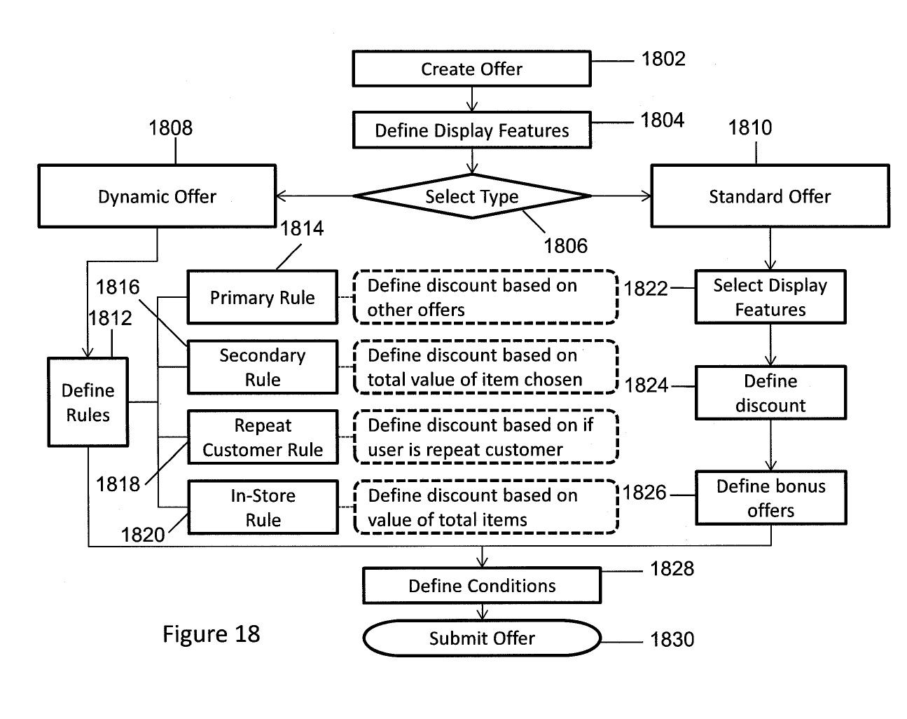

As shown in FIG. 18, when a seller chooses to create and offer 1802, the seller has the option of defining the display features 1804. This includes the title of the product, the description of the product, images of the product, category for the product, retail price, etc. The seller also has the option 1806 of creating a dynamic offer 1808 or a standard offer 1810. If a dynamic offer is being created, the seller can define the rules 1812 for which the discount amount will be calculated. The rules can consist of preliminary rules, primary rules 1814, secondary rules 1816, repeat customer rules 1818, and in-store rules 1820, and the like. If the seller is creating a standard offer, the seller selects the display features 1822, defines the discount 1824, and defines any bonuses 1826.

For either the dynamic offer or the standard offer, the seller can establish other bonuses, conditions 1828, and limitations. Once the offer has been defined, the seller submits the offer 1830 for the consumer to view.

The system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an apparatus or device that utilizes or implements electronic, magnetic, optical, electromagnetic, infrared signal or other propagation medium, or semiconductor system. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of generating a variable discount coupon, comprising:
a. displaying a plurality of images, each image representing an item available for discount, each item having an item-specific discount amount;
b. receiving a selection of a first item;
c. displaying an image of the first item selected with a first item-specific discount amount;
d. receiving a selection of a second item;
e. displaying an image of the second item selected with a second item-specific discount amount;
f. updating the first item-specific discount amount based on the second item selected; and
g. displaying a total discount as a coupon to be redeemed at a store.

2. The method of claim 1, further comprising:
a. receiving a selection of an additional item;
b. displaying an image of the additional item selected with an additional item-specific discount amount; and
c. updating any pre-existing selected item's item-specific discount amount based on the additional item selected.

3. The method of claim 1, further comprising:
a. receiving a request to print the coupon; and
b. printing the coupon.

4. The method of claim 3, wherein selected items available at a first store printed on the coupon requires a consumer to purchase all of the selected items at the first store together from the first store to receive the total discount.

5. The method of claim 1, further comprising sending the coupon to a mobile device.

6. The method of claim 1, further comprising allowing a seller to establish a set of rules for determining the item-specific discount amount.

7. The method of claim 1, further comprising sending a rebate in an amount equal to a total savings.

8. A variable discount coupon generating system, comprising:
a. a server connected to a network, the server receiving requests from users via the network, the server comprising:
i. at least one processor;
ii. a database for storing product information; and
iii. a memory operatively coupled to the processor, the memory storing program instructions that when executed by the processor, causes the processor to:
1. receive a plurality of product selections from a user via the network, wherein each product selected comprises a discount information;
2. determine a discount amount for each of the plurality of products selected, based on the discount information; and
3. display each of the discount amounts to the user via the network, wherein the discount amounts of each product are dependent on the discount information of other selected products.

9. The variable discount coupon generating system of claim 8, further comprising:
a. receiving a request to print the coupon; and
b. printing the coupon to a device selected from the group consisting of a printer and a mobile device.

10. The variable discount coupon generating system of claim 8, wherein the plurality of product selections at a first store printed on the coupon requires a consumer to purchase all of the plurality of product selections together at the first store to receive a discounted price.

11. The variable discount coupon generating system of claim 8, wherein the processor generates a management page showing information regarding a user's coupon activity.

12. The variable discount coupon generating system of claim 8, wherein a consumer receives a rebate in an amount equal to a total savings.

13. A variable discount coupon generating system, comprising:
a. at least one processor; and
b. a memory operatively coupled to the processor, the memory storing program instructions that when executed by the processor, causes the processor to perform steps comprising:
i. displaying on a monitor a plurality of products available for a discounted price, each product having a discount amount;
ii. allowing a consumer to select a first product to be purchased;
iii. displaying on the monitor the discount amount of the first product;
iv. allowing the consumer to select additional products to be purchased;
v. after each additional product is selected, updating the discount amount of each selected product to create an updated discount amount for each selected product, the updated discount amount being dependent on other selected products; and
vi. displaying the updated discount amount of each selected product after each additional product is selected.

14. The variable discount coupon generating system of claim 13, wherein the at least one processor generates a coupon for redemption.

15. The variable discount coupon generating system of claim 14, wherein the coupon is sent to mobile device.

16. The variable discount coupon generating system of claim 13, wherein the processor causes a consumer management page to be displayed, the consumer management page containing information regarding a consumer's coupon generating activities.

17. A variable discount coupon generating system, comprising:
a. a server connected to a network, the server receiving a product information for a plurality of products from a seller via the network, the server comprising:
i. at least one processor;
ii. a database for storing the product information; and
iii. a memory operatively coupled to the processor, the memory storing program instructions that when executed by the processor, causes the processor to:
1. receive the product information from the seller, wherein the product information comprises a discount information, wherein the discount information comprises a set of rules to determine a discount amount;
2. save the product information to the database; and
3. display the product information to a consumer.

18. The variable discount coupon generating system of claim 17, wherein the discount amount is dependent on a product information of other selected products by the consumer.

19. The variable discount coupon generating system of claim 17, wherein the processor creates a seller management page displaying information regarding a seller's coupon generating activity.

20. The variable discount coupon generating system of claim 17, wherein a seller management page displays information regarding coupon redeeming activity in an area.
